(19) United States
(12) Patent Application Publication
(10) Pub. No.: US 2026/0017648 A1
(43) Pub. Date: Jan. 15, 2026

(54) TRANSACTION SECURITY FOR NONENFORCED DOMAIN CONTROL RESTRICTIONS BY A PAYMENT PROCESSOR

(71) Applicant: ITS, Inc., Johnston, IA (US)

(72) Inventors: Scott GREEN, Little Rock, AR (US); Nathwani MANISH, Johnston, IA (US)

(21) Appl. No.: 18/770,160

(22) Filed: Jul. 11, 2024

(51) Int. Cl. G06Q 20/38; G06Q 20/40

(52) U.S. Cl. CPC G06Q 20/388; G06Q 20/40

(57) ABSTRACT

A merchant provisions a merchant provisioned token from a token service provider. The merchant sends a transaction authorization request, including the merchant provisioned token received from the token service provider to an alternate payment processor. The token service provider does not enforce the domain control restriction by indicating the merchant domain for which the merchant provisioned token was provisioned. The alternate payment processor validates a first set of token information received in the transaction authorization request with token reference information received form the token service provider. The alternate payment processor then indicates whether the token information on the transaction matches the token reference information. The card issuer and merchant may use this information to assist in their decisions to proceed with the transaction or decline the transaction.

### BACKGROUND

Online merchants increasingly rely on third party payment processors to accept various forms of payment and to protect sensitive payment information from fraud and data breaches. Third party payment processors implement security measures such as tokenization, which replaces sensitive data with a unique identifier that retains essential information without compromising security. Tokenization presents challenges in payment environments where there are multiple payment processors. The payment processor who issues the initial token is able to enforce the token domain restrictions, but alternate payment processors are not able to enforce the domain restrictions because they lack access to the domain index where the necessary information for domain restriction enforcement is stored. When payments are processed through other alternate payment processors, the domain restriction security may be unavailable.

### SUMMARY

At a high level, aspects described herein relate to an alternate payment processor verifying merchant provisioned token reference information when token domain restrictions are not enforced by a token service provider that issued the token, and the alternate payment processor does not have access to the domain index where the domain restriction enforcement information is stored.

To do so, when the alternate payment processor receives a customer transaction request from a merchant, and the token service provider does not enforce the domain control restriction, the alternate payment processor may compare the token information received from the merchant in the customer transaction request with a set of token reference information received from the token service provider in response to a PAN (primary account number) mapping request. Such token reference information may include the token requestor identification (ID) and the type of transaction, for example a card-not-present transaction.

The alternate payment processor may then indicate, to the issuer in an authorization request and later to the merchant when routing the authorization response, whether the token information provided in the transaction matches the set of token reference information from the domain index. Both the issuer and the merchant can take this information into consideration when deciding whether to authorize or decline the transaction.

This summary is intended to introduce a selection of concepts in a simplified form that is further described in the Detailed Description section of this disclosure. The Summary is not intended to identify key or essential features of the claimed subject matter, nor is it intended to be used as an aid in determining the scope of the claimed subject matter. Additional objects, advantages, and novel features of the technology will be set forth in part in the description that follows, and in part, will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is an example operating environment in which implementations of the present technology can be employed, in accordance with an aspect described herein;

FIG. 2 is a block diagram illustrating a merchant provisioning a merchant provisioned token from a token service provider, in accordance with an aspect described herein;

FIG. 3 is a diagram illustrating transaction processing, in accordance with an aspect described herein;

FIG. 4 is a flow chart of an example method for verifying a transaction when domain restrictions are not enforced by a payment processor;

FIG. 5 is a flow chart of another example method for verifying a transaction when domain restrictions are not enforced by a payment processor; and

FIG. 6 is an example computing device suitable for executing aspects of the technology described herein, in accordance with an aspect described herein.

### DETAILED DESCRIPTION

Consumers may wish to make online, phone or mail orders from a merchant, and to have the merchant store their payment card information for convenience during future transactions. To provide the consumers with future “card-not-present” transactions, the merchant routes the cardholder’s information to a token service provider, which may also be a payment processor that facilitates payment processing, who then stores the cardholder’s information in a domain control index. The index cross references the cardholder’s information with an assigned merchant provisioned token, which is generated by the token service provider specifically for the merchant requesting payment processing. The merchant provisioned token is then provided to the merchant to store for future transactions. In this way, the consumer can conduct future transactions with the merchant without presenting the original card. At the same time, the merchant can store the merchant provisioned token rather than the consumer card information, thus providing an additional level of security for the merchant.

When the cardholder wishes to make subsequent transactions, the merchant provides the merchant provisioned token to the token service provider for payment processing. The token service provider verifies the cardholder’s information using the domain index and processes the transaction. The token service provider may choose to also verity the domain of the merchant provisioned token by determining the merchant providing the token is the same merchant for which the token was provisioned. This is referred to as domain control enforcement or domain control restriction. Domain control restrictions enhance security by reducing the risk of fraud in case the token details are compromised, as the token cannot be used outside of its designated domain.

Currently, if a merchant wishes to use an alternate payment processor other than the token service provider for subsequent transactions, the token service provider may chose not to enforce the domain control restrictions. That is, the merchant may send a merchant provisioned token issued for the merchant by a token service provider to an alternate payment processor for processing. The alternate payment processor may then seek to verify the domain control restriction information by requesting the information from the token service provider. The token service provider may choose not to provide the alternate payment processor with the domain control restriction information, including the type of transaction the token was provisioned for or the merchant the token was provisioned for. Instead, the token service provider may choose to provide a limited set of token reference information that corresponds to the merchant provisioned token, which includes items such as the token requestor ID, a PAN, the token assurance level, and the token assurance method. In this scenario, the alternate payment processor cannot enforce the domain control restriction, since the necessary data is stored by the token service provider’s domain control index.

The technology presented by this disclosure provides methods whereby an alternate payment processor may enhance the security of a card-not-present transaction, initiated by a merchant, when the request includes a merchant provisioned token issued by a token service provider and the token service provider does not to enforce the domain control restrictions for the merchant provisioned token.

As disclosed herein, when an alternate payment processor receives a request to process a card-not-present transaction, the alternate payment processor will attempt to verify the information received in the request matches the information stored in the domain index database of a token service provider. If, however, the token service provider only provides certain token reference information to the alternate payment processor, and does not provide access to all of the information stored in the domain index database, such as the domain information, the alternate payment processor may choose to authenticate the transaction using discrete information. In other words, when the information received from the merchant cannot be verified with the information in the domain index database for which it was created to be verified, the alternate payment processor may choose to find an alternate way to verify the information received from the merchant matches the information that is available from the token service provider. The methods provided herein enable an alternate payment processor to securely process a card-not-present transaction while protecting sensitive payment card information, assuring merchants the alternate payment processor is limiting their exposure to fraud and data breaches, even in instances where domain control restrictions are enforced only by the token service provider.

As background, customers have long enjoyed the convenience of using credit or debit cards to purchase goods or services from merchants. Such cashless transactions were first processed manually using a payment card imprinter. When a customer would present a card to the merchant for payment processing, the merchant would place the customer’s card on the bed of the imprinter and, using carbon paper, create a carbon copy imprint of the card details on the sales slip. The customer would then sign the sales slip as an authorization for the transaction. The merchant would later submit the sales slip to the customer’s bank for processing. This manual process was time consuming and prone to human error, which lead to the development of electronic card readers.

Electronic card readers eventually displaced the manual imprinting of a customer’s payment card information. Magnetic stripe technology was introduced on cards, allowing a faster, more efficient way to process card transactions with less chance of human error. Electronic data interchange or EID technology was developed, which played a crucial role in facilitating the authorization and processing of payment between merchants and banks. However, card transactions using electronic card readers still had to be done in person, or over the phone, or by mail. If done in person, the customer, the merchant, and the electronic card reader had to be physically in the same place so that the merchant could swipe the customer’s card. With phone or mail in transactions, the merchant had to physically input the customer’s card information into the electronic card reader. Later, with the rise of the internet, merchants began seeking ways to allow customers to make online purchases using a credit or debit card that did not involve manually entering the customer’s payment card information into an electronic card reader.

Online payment gateways were developed to facilitate online transactions. These payment gateways initiated the secure transfer of consumer information, including payment card information, between a payment portal such as a website and a payment processor or bank. This allowed merchants to directly accept payments from customers over the internet using any standard computing device, as opposed to a specific purpose merchant terminal. This advancement lead to the growth of e-commerce.

The rise of e-commerce and payments acceptance at common computing devices necessitated changes to payment data security associated with online payment processing. Merchants sought ways to limit or prevent database breaches, and to identity theft and payment card fraud. To aid merchants in this endeavor, some payment processors began to provide merchant website integrated payment forms, such as an embedded webpage or a redirect page, to collect payment details and complete payment processing for transactions made on merchant websites.

With the ease and convenience of online shopping, customers may want to make multiple purchases from a merchant over a period of time. To make it easy for a customer to make multiple purchases, merchants desire to make completing future purchases as easy as possible for the customer. One of the ways merchants do this is by allowing a customer to make future purchases without re-entering their payment card information into the merchant’s website. It is beneficial for the merchant if the customer can simply log into the merchant’s website and complete an online transaction without re-entering their credit card information. Merchant’s may also wish to allow customers to pay for items over a period of time using multiple sequential payments, historically requiring them to maintain sensitive payment information. However, merchants do not wish to store sensitive payment card details on their own servers, which could increase their liability for security breaches.

Because of these security issues, a merchant may use a token service provider for payment processing that issues a merchant provisioned token specific to that merchant. When a customer enters their payment details at the merchant, e.g., the merchant website or into the token service provider’s interface on the merchant’s website, the information is routed to the token service provider for payment processing and issuance of a merchant provisioned token. The token service provider issues a merchant provisioned token for a specific customer for a specific merchant. During this process, the token service provider stores information about the merchant provisioned token in its domain control index, including a merchant specific identifier, also referred to as the token requestor ID. The purpose of indexing the information is to verify that the merchant provisioned token is being used by the specific merchant for whom it was intended and for the usage intended. Verifying the merchant provisioned token is being used for the specific merchant and purpose it was intended is referred to as token domain control. As an example, a merchant provisioned token may be issued for a specific merchant or for a specific purpose, such as to provide a series of sequential payments over a defined period of time.

By receiving and storing a merchant provisioned token, the merchant does not store sensitive card details on its own servers, which minimizes its liability and enhances security. Token service providers provide merchant provisioned token options by handling the storage of customer payment card information and issuing the merchant provisioned token that the merchant can then store for use in future transactions involving a customer. In this way, the token service provider maintains the real PAN on behalf of the merchant, and provides the merchant specific token that can be used to reference the PAN when received by corresponding merchant and for the specified purpose.

While the development and use of merchant provisioned tokens with domain restrictions enhanced security, it also introduced a new problem specific to payment environments where there are multiple payment processors, including payment processor distinct form the token service provider. From a technical standpoint, one payment processor (the token service provider) is able to enforce the merchant provisioned token domain restrictions either itself or in choosing to provide the domain restriction information from the domain index. As such, alternate payment processors may not be able to enforce the domain restrictions because they lack access to the domain index where the necessary information for domain restriction enforcement is kept. In essence, the introduction and use of more secure domain restrictions has limited the use of merchant provisioned token domain restrictions by other payment processors in the payment ecosystem. When payments are processed through other processors, the domain restriction security may be unavailable.

As an example, to issue a merchant provisioned token, a customer enters their payment details, including their name, payment card number, card verification value (CVV), personal identification number (PIN), address, etc. on a merchant website to complete a purchase transaction. There may be a need to maintain the payment information, such as subsequent uses of the payment card. The card details may be routed to a token service provider for processing, including storing for future transactions. A token service provider may sometimes be referred to as a payment processor or provider, or may be referred to more generally as a payment network. Once the payment details are received by the token service provider, the token service provider stores the information in a domain index. The domain index is tailored to the specific characteristics of the data and the types of inquiries that will be performed on the data, in this case, information related to a payment transaction involving a merchant and customer payment card information. Information such as token requestor identification (ID) that identifies the merchant requesting the token, merchant provisioned token, PAN, and transaction type, may be cross-referenced in the token service provider’s domain index. The domain index is then used to access account information suitable for processing a payment when queried using a merchant provisioned token, along with accessing domain specific information identifying the merchant to ensure the integrity of the transaction.

When a token service provider receives a request for a merchant provisioned token routed from a merchant, which in some cases includes a simultaneous request to process a customer’s payment card information for a purchase, the token service provider will receive the information and issue a merchant provisioned token, which the merchant can store for use in future transactions with the customer. In this scenario, the merchant is the token requestor and they are requesting the token service provider provide them a merchant provisioned token. A merchant provisioned token is unique identifier that replaces the customer’s payment card information and it is specific to the merchant, and in some cases, may be issued for a specific purpose with the merchant or a specific transaction type, such as a card-not-present transaction. Even if the token is intercepted, it cannot be used outside the context for which it was created for, i.e., “domain control” or “domain restriction,” in this case for a specific merchant and a card-not-present transaction, since the information needed to process the transaction, like the PAN, is kept within the domain index.

By replacing the customer’s payment card information with a merchant provisioned token, the merchant can store the token and process future transactions in accordance with the domain restrictions without the risk of the customer’s payment card information being compromised. In this way, the merchant can protect itself from liability associated with storing the customer’s payment card information. As part of the process of issuing the merchant provisioned token, the token service provider will index the assigned merchant provisioned token in the domain index, and cross-reference the merchant provisioned token with other information including the customer payment card information, such as the PAN, which is also stored in the domain index. The merchant provisioned token is then sent to the merchant to be stored by the merchant for use in future transactions with the customer. The domain index can also store domain information for the merchant for which the merchant provisioned token was issued. As such, when a merchant provisioned token is received, identifying information for the entity sending the merchant provisioned token can be cross-checked with the domain index to ensure the merchant provisioned token is received through the rightful channel.

When a customer initiates a subsequent card-not-present transaction with the merchant, the merchant can use the stored the merchant provisioned token issued by the token service provider instead of the clear text PAN. If the merchant choses to use the token service provider to process a subsequent transaction, the token service provider will receive the merchant provisioned token information, verify the merchant sending the merchant provisioned token is associated with the merchant provisioned token (i.e., enforcing domain restrictions), apply any other domain control restrictions, and cross reference the merchant provisioned token to the customer payment card information stored in the domain index. In other words, the token service provider will map the merchant provisioned token back to the original PAN stored in the domain index. This is referred to herein as PAN mapping.

Once PAN mapping is complete, the token service provider may initiate an authorization request to the payment card issuer using the mapped PAN. The request is sent to the payment card issuer to verify the availability of funds associated with the PAN and check for potential fraud. The payment card issuer then responds to the authorization request by approving or declining the transaction. If the transaction is approved, the card issuer provides an authorization approval, which is sent to the token service provider as an authorization response. The authorization response indicates the transaction has been approved and funds are available. The token service provider then sends the authorization response to the merchant’s payment gateway or point of sale (POS) system where the transaction can proceed.

As discussed above, with the rise of online shopping, merchants have increasingly relied on service providers to provide payment processing including a secure payment form, such as an embedded webpage or a redirect page, to collect payment details, and to complete transactions made on merchant websites. Merchants have a choice in which payment processor they use for payment processing. This choice allows merchants to select a provider that best serves its needs. Merchants may consider factors such as security and compatibility with their own data processing when choosing a payment processor to complete payment processing. As the needs of a merchant may be ever-changing, so, too, may the considerations affecting a merchant’s choice of payment processor used for payment processing also change.

Returning to the subsequent card-not-present transaction initiated by a returning customer discussed above, as stated, when a customer initiates a subsequent card-not-present transaction with the merchant, a subsequent sequential transaction is initiated by the merchant, or the like, the merchant could instead choose to use an alternate payment processor that is different than the token service provider to process the subsequent transaction. The alternate payment processor may be distinct from the token service provider in that it does not share access to the domain index. The alternate payment processor may be referred to as another payment network. When the alternate payment processor receives the merchant provisioned token information from the merchant, it will not be able to cross reference the merchant provisioned token to the customer payment card information stored in the domain index. The token service provider, at the request of the alternate payment processor, provides the required PAN information responsive to PAN mapping. However, the token service provider may chose not to enforce the domain control restrictions for transactions routed from the alternate payment processor by not providing the alternate payment processor with an indication of the domain control information typically evaluated during the PAN mapping.. Put another way, the token service provider has access to the domain index that contains the information required to enforce domain control on transactions associated with the merchant provisioned tokens. However, the token service provider may choose not to indicate domain specific merchant or purpose for the merchant provisioned token when the PAN mapping request is received from the alternate payment processor. Essentially, the token service provider chooses to only apply the domain restrictions when transactions are routed directly to it from the merchant or other approved entity.

The disclosure herein provides methods for an alternate payment processor to process a card-not-present transaction in a secure manner using information in the transaction request and token reference information received during PAN mapping that is associated with a merchant provisioned token issued by a token service provider. This may be done when the token service provider does not enforce the domain restrictions by not indicating merchant or purpose specific restrictions of the merchant provisioned token during PAN mapping requests from the alternate payment processor and including indications of exceptions in its response to the alternate payment processor.

When a merchant routes a transaction request that includes a merchant provisioned token to a second or alternate payment processor, the alternate payment processor cannot verify the domain for which the merchant provisioned token was created for because that information is stored in a token service provider’s domain control index. Instead, the token service provider may request detokenization and verification of token domain control from the token service provider. In some cases, the token service provider will provide reference token information during detokenization, but will not enforce the domain control restriction. That is, the token service provider may refuse to indicate a specific merchant or purpose corresponding to the merchant provisioned token, e.g., whether any particular domain control restrictions were violated. As a result of the token service provider not enforcing the token domain control restriction, the alternate payment processor may use the reference token information received from the token service provider and compare it to token information supplied by the merchant in the merchant’s transaction request. The alternate payment processor may then include token verification results in the authorization request it routes to the issuer and in the response to the merchant. This way both issuer and the merchant can consider the verification results when approving and finalizing the transaction.

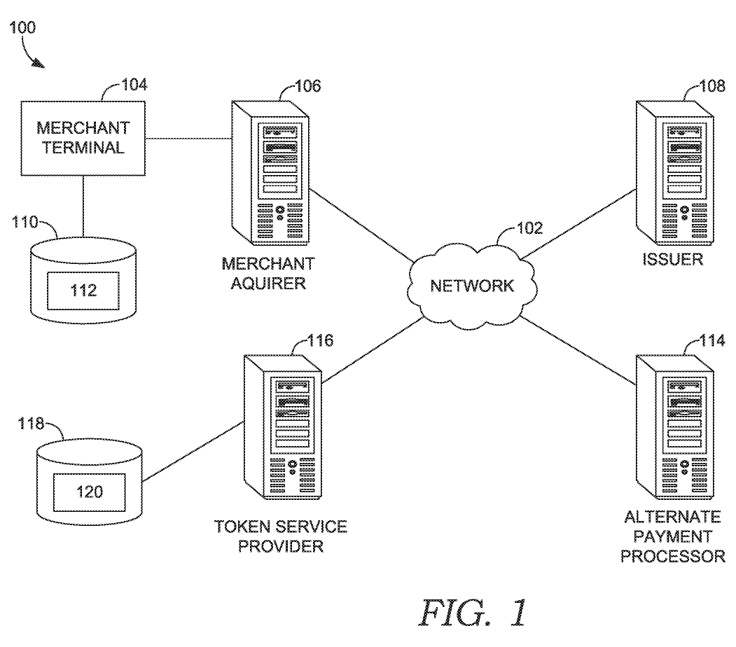

Turning now to FIG. 1, FIG. 1 illustrates example operating environment 100 in which the methods may be implemented. In particular, FIG. 1 illustrates a high-level architecture of an operating environment 100 that has components suitable for use with the described methods. Among other components not shown, operating environment 100 merchant terminal 104, merchant acquirer 106, merchant database 110, merchant provisioned token 112, issuer 108, alternate payment processor 114, token service provider 116, token service provider database 118, and domain index 120. Components of operating environment 100 are shown communicating using network 102.

It is noted that any number or combination of components may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Further, although some components of FIG. 1 are depicted as single components, the depictions are intended as examples in nature and in number, and are not to be construed as limiting for all implementations of the present disclosure.

Continuing with FIG. 1, in general, merchant terminal 104 is a hardware system that is used to facilitate a financial transaction. In a specific embodiment, merchant terminal 104 facilitates a financial transaction in conjunction with merchant acquirer 106. Merchant acquirer 106 may otherwise be referred to as one or more servers hosted by an acquirer. Merchant acquirer 106 may take the form of a computing device. Merchant acquirer 106 may perform tasks associated with processing financial transactions. Merchant acquirer 106 may include within its network one or more merchant terminals 104 in communication with merchant acquirer 106. In practice, the merchant acquirer 106 may sometimes be referred to as a “processor.” In an aspect, merchant terminal 104 is a point-of-sale terminal. In an aspect, merchant terminal 104 communicates with the client computing device receiving input to initiate a transaction. For instance, merchant terminal may process payments for an online merchant accessed by a client computing device.

Issuer 108 comprises one or more servers hosted by a payment card issuer. Issuer 108 may take the form of a computing device. Issuer 108 may perform various tasks associated with the issuance or maintenance of a financial instrument, such as a credit or debit card, or a financial account. Issuer 108 may perform tasks that include verifying whether such financial instruments or accounts are authentic, and whether accounts have the appropriate funds to process a transaction. Issuer 108 may perform other accounting functions, such as balancing or settling accounts associated with a given transaction.

Network 102 may include one or more networks (e.g., public network or virtual private network “VPN”). Network 102 may include one or more local area networks (LANs), wide area networks (WANs), or any other wired or wireless communication network or method. Network 102 may use any type, or any combination, of communication protocol to facilitate the exchange of information between any of the components.

Merchant database 110 generally stores information including data, computer instructions (e.g., software program instructions, routines, or services), or models used in embodiments of the described technologies. Although depicted as a single database component, merchant database 110 may be embodied as one or more databases or may be in the cloud. In a specific embodiment, merchant database 110 stores merchant provisioned token 112 issued by token service provider 116.

Token service provider 116 may comprises one or more servers hosted by a payment processor, also referred to herein as a payment provider or a third party service provider. In an aspect, the payment processor may also be a payment card issuer, such as the one supporting issuer server 108. Token service provider 116 may perform various tasks associated processing payments and financial transactions between a merchant and a customer. Token service provider 116 may perform tasks that include verifying information received from the merchant, including customer payment information, is authentic. Token service provider 116 may receive payment card information from a merchant, such as one hosting merchant terminal 104, and creates and provides to the merchant a merchant provisioned token 112 specific to the merchant or purpose. and its intended use.

Token service provider database 118 generally stores information including data, computer instructions (e.g., software program instructions, routines, or services), or models used in embodiments of the described technologies. Although depicted as a single database component, Token service provider database 118 may be embodied as one or more databases or may be in the cloud. In a specific embodiment, token service provider database 118 stores domain index 120, which indexes merchant provisioned tokens 112 to specific merchants identified by their token requestor IDs, as will be further described.

Alternate payment processor 114 is generally hosts one or more servers for processing payments. Like the token service provider 116, each may comprises a payment network in which their respective servers operate to facilitate payment processing or other respective tasks. . Alternate payment processor 114 may perform various tasks associated with processing payments and financial transactions, such as acting as a payment network that routes merchant request and transaction information to issuers. Payment processors in general may also provide additional functionality within the payment ecosystem, such as requesting or facilitating PAN mapping, and may take other actions to reduce fraudulent transactions. For instance, the token service provider 116 may issue merchant provisioned token. As another example, the alternative payment processor 114 may verify token information with token reference information, as will be further discussed, in an effort to identify potentially fraudulent transactions, particularly if the token service provider 116 does not enforce domain restriction, as may happen for card-not-present transactions. Alternate payment processor 114 may perform tasks that include verifying information received from the merchant, including customer payment information, is authentic.

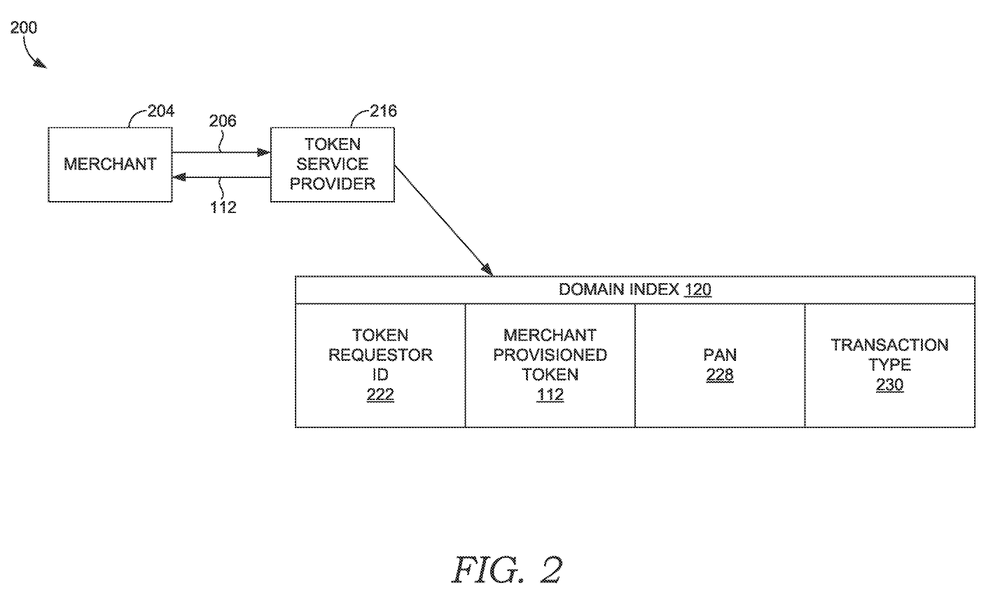

FIG. 2 is a block diagram illustrating provisioning of a merchant provisioned token 112 by a token service provider. Merchant 204 sends a merchant provisioned token request 206 to a token service provider 216. This request includes details about the merchant, such as the merchant ID, name, and location. The request also includes details of the payment card that need to be tokenized, such as the PAN 228, cardholder name, expiration date, and card verification code (CVV). In aspects, the request may include the domain name of the merchant’s website or the domain under which the merchant operates, e.g., a “merchant domain,” or other merchant identifying information. In an aspect, the token requestor ID 222 is used to validate the origin of the request and ensure it matches the registered domain for the merchant. In an aspect, the token requestor ID 222 is issued by the token service provider. In some cases, a new token requestor ID may be issued when a merchant provisioned token. The token requestor ID 222 is mapped by the token service provider 216 to the issued merchant provisioned token 112 to restrict processing of payments using the merchant provisioned token 112 to only those transactions where the merchant provisioned token request 206 is received from the merchant corresponding to the token requestor ID 222 and meet other criteria established in the restrictions, such as a specified purpose for the merchant provisioned token 112.

As is shown in FIG. 2, the token service provider 216 processes the merchant provisioned token request 206 from merchant 204. As part of processing the request, the token service provider 216 creates a merchant provisioned token 112. The merchant provisioned token 112 may comprises any sequence of characters, which may be unique from other merchant provisioned tokens and used to reference domain restriction information from the 120 responsive to a transaction request. The token service provider 216 then stores the merchant provisioned token 112 in domain index 120. Additional information is stored in domain index 120 and is cross-referenced with the merchant provisioned token 112 in the token service provider’s 216 domain index 120. Such information may include token requestor identification (ID) 222, the PAN 228, and transaction type 230. The token requestor ID 222 is a unique identifier used for the entity to whom the token was provided for storage and use (generally the merchant or an agent of the merchant). The token requestor ID 222 is assigned to the token requestor, in this example the merchant. The token requestor ID 222 is linked to the requestor and helps in associating tokens specific to the merchant and token transactions with the merchant identity. . After the token service provider 216 has issued the merchant provisioned token 112 and indexed the token in domain index 120, token service provider 216 sends the merchant provisioned token 112 to merchant 204 for storage and use in future transactions. In an aspect, the merchant provisioned token 112 was issued for a specific domain of a merchant, meaning that the merchant provisioned token may be restricted for use to only a particular domain name associated with the merchant.

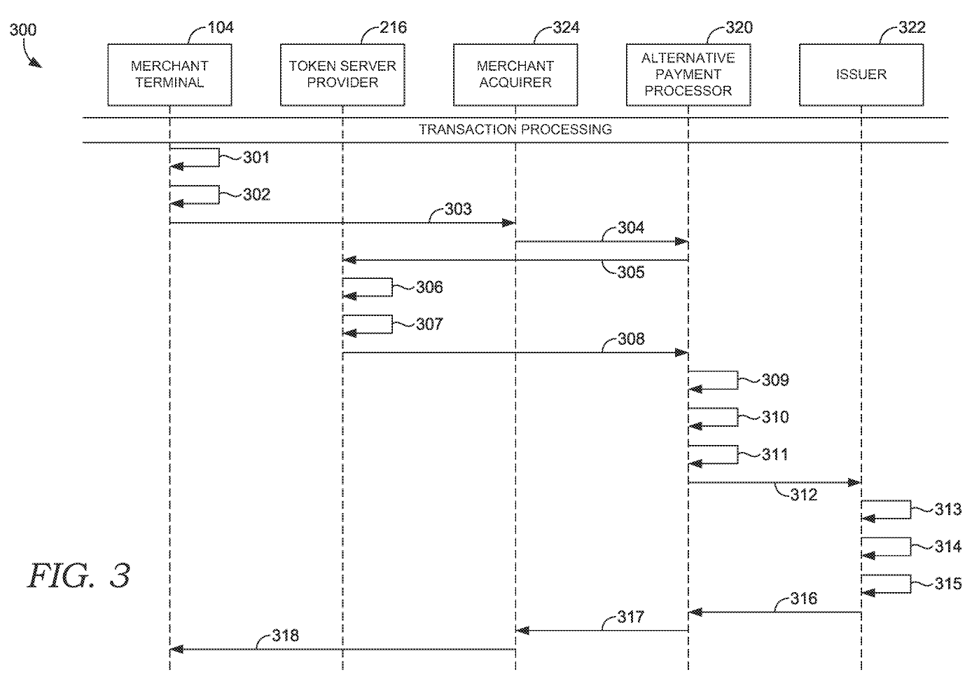

Turning now to FIG. 3, FIG. 3 is a diagram illustrating an example transaction processing diagram 300 using a merchant provisioned token 112, such as the one issued with reference to FIG. 2. In particular, the transaction process according to transaction processing diagram 300 may be employed when a merchant requests a transaction processing via an alternate payment processor 306 that is different from the token service provider 216 that issued the merchant provisioned token 112. In a specific aspect, the transaction process illustrated may be used to enhance security of the transaction when the first payment process that issued the merchant provisioned token 112 does not enforce domain restrictions for the merchant provisioned token 112.

Beginning at the merchant terminal 104, at step 301 of FIG. 3, the merchant 204 accesses the merchant provisioned token 112 and information necessary to complete the transaction. In an aspect, the merchant provisioned token 112 was provisioned by the token service provider 216 and provided to the merchant 204 to store in the merchant database 110 for future use. At step 302, the merchant adds the merchant provisioned token 112 to token information that is included within an authorization request for the transaction. The token information may further include a token requestor ID, such as token requestor ID 222, identifying the merchant for which the merchant provisioned token 112 was issued. Moreover, the merchant provisioned token may indicate a transaction type 230 for which the merchant provisioned token 112 was provisioned. The merchant or its acquirer, generally referred to as “merchant,” may include other additional information that may also be compared to token reference information in the domain index to determine if a transaction should be restricted base upon domain controls.. In an aspect, the merchant provisioned token 112 was provisioned by the token service provider 216 for use associated only with the merchant corresponding to the token requestor ID 222 for which the merchant provisioned token was provisioned and for the usage intended

At step 303, the merchant sends the authorization request, including the first set of token information and the merchant provisioned token 112, to the merchant acquirer 324. The first set of token information may include a token requestor ID 222 and an indication of the type of transaction type 230. At step 304, the merchant acquirer routes the authorization request to an alternate payment processor 320 different from the token service provider 216. At step 305, the alternate payment processor 320 sends a PAN-mapping request to the token service provider 216 for the token associated with a token transaction 112 received from the merchant acquirer 324token service provider. At step 306, the token service provider 216 maps the merchant provisioned token 112 provided by the alternate payment processor 320 to the PAN 228. This is done by referencing the domain index 120 stored on the token service provider server 116. token service provider alternate payment processor

At step 307, the token service provider 216 adds token reference information to the PAN mapping response. The token reference information may include the token requestor ID 222 and a PAN 228 that can be used to process the payment with issuer 322. In addition to sending the token reference information, the token service provider 216 may choose to enforce the domain control restriction by indicating the merchant for which the merchant provisioned token 112 was provisioned. In an aspect, the token service provider 216 does not enforce the domain control by not indicating the merchant for which the merchant provisioned token 112 was provisioned.

At step 308, the token service provider 216 sends the response to the PAN mapping request back to the alternate payment processor 320. At step 309, the alternate payment processor 320 compares the token transaction information received from the merchant acquirer 324 to the token reference information provided by the token service provider 216. In an aspect, in response to the PAN mapping request, the token service provider 216 does not enforce the domain control restriction by indicating any failures of verifications for applicable restrictions, such as not indicating the specific merchant or purpose for which the merchant provisioned token was used, to the alternate payment processor 320. In response to the domain control restriction not being enforced by the token service provider 216, the alternate payment processor 320 may verify the token requestor ID 222 received from the merchant acquirer 324 is the same as the token requestor ID 222 received from the token service provider 216 or otherwise indicated by the merchant provisioned token 112 or by the authorization request. The alternate payment processor 320 may also verify the transaction type 230 indicated by the merchant acquirer 324 in the transaction request is the same as the type of transaction type 230 received from the token service provider 216 or otherwise indicated by the merchant provisioned token 112 or by the authorization request.

In aspects, the token service provider 216 may enforce domain control restrictions based on a transaction type. For example, some token service providers enforce domain control restrictions for card present transaction or digital wallet transactions. Thus, by not indicating that the merchant provisioned token 112 was provisioned specifically for a particular merchant, e.g., 204, or purpose, i.e., not enforcing the domain control restrictions, the token service provider 216 may indicate the particular type of transaction for which the merchant provisioned token 112 was issued. For instance, where the token service provider 216 does not enforce the domain restrictions, this may indicate that that merchant provisioned token 112 was issue for a particular transaction type 230, such as a card-not-present transaction. The indication of the transaction type 230 provided by (or otherwise inferred from) the token service provider 216 can be compared the transaction type received as part of the transaction request with token information from the merchant 204, as will be described.

For example, if the domain control restriction is not enforced, and the transaction request from the merchant acquirer 324 is a request to process a card-not-present transaction, alternate payment processor 320 may verify the transaction type 230 received from the token service provider 216 is also a card-not-present transaction. In this example, there may be no indication from the token service provider 216 that the token requestor ID 222 identified in the domain index 120, or the other restrictions such as the types of transactions allowed, are the same as what is specified in the token reference information in the domain index. Similarly, if the domain control restriction is not enforced, and the transaction request from the merchant acquirer 324 includes a token requestor ID 222, alternate payment processor 320 may verify that the token requestor ID 222 received from the token service provider 216 during PAN mapping is the same as the token requestor ID 222 received from the merchant acquirer 324 in the transaction request.

In an aspect, as illustrated using step 310, the alternate payment processor 320 may approve or decline the transaction based on whether there is a match between the token information received from the merchant (e.g., the token requestor ID or the transaction type) and the token reference information received from the token service provider during the PAN mapping, e.g., whether there is a match between the token requestor IDs 222 or the transaction types 230. In an aspect, the alternate payment processor 320 approves or declines the transaction based on the token reference information only when domain control restrictions are not enforced by the token service provider 216. It will be understood, that in some aspects, the alternate payment processor 320 may not decline or approve the transaction, but rather will provide an indication whether various elements of the token information match to the card issuer or merchant acquirer 324, either of which may decline or approve the transaction in response, as will be described.

At step 311, the alternate payment processor 320 adds the token information to an authorization request. This may include an indication whether the token information matches the token reference information. At step 312, the alternate payment processor 320 communicates the authorization request, including the PAN 228 and token information to the issuer 322. At step 313, the issuer 322 evaluates the token information received from the alternate payment processor 320. At step 314, the issuer 322 approves the transaction using the PAN 228 and creates an authorization response. At step 315, the issuer 322 generates an authorization response. The authorization response may include token information. At step 316, the authorization response is sent to the alternate payment processor 320. At step 317, the authorization response is routed from the alternate payment processor 320 to the merchant acquirer 324. In aspects, the alternate payment processor 320 may include an indication of the various matching information to the merchant acquirer 324. For example, the alternate payment processor 320 may include an indication the token requestor ID received from the token service provider 216 is the same as the token requestor ID received from the merchant acquirer 324 or otherwise indicated by the merchant provisioned token 112 or by the authorization request. The alternate payment processor 320 may also indicate the token requestor IDs do not match. The merchant acquirer 324 may then approve or decline the transaction based on the information received from the alternate payment processor 320.

Similarly, the alternate payment processor 320 may indicate the transaction type indicated by the merchant acquirer 324 in the transaction request is the same as the transaction type received from the token service provider 216 or otherwise indicated by the merchant provisioned token 112 or by the initial authorization request. The alternate payment processor 320 may also indicate the transaction types do not match. The merchant acquirer 324 may then approve or decline the transaction based on the information received from the alternate payment processor 320. Finally, at step 318, after making a decision to approve or decline the transaction, the merchant acquirer 324 may route the authorization response back to the merchant terminal 104 where the merchant can complete or terminate the transaction.

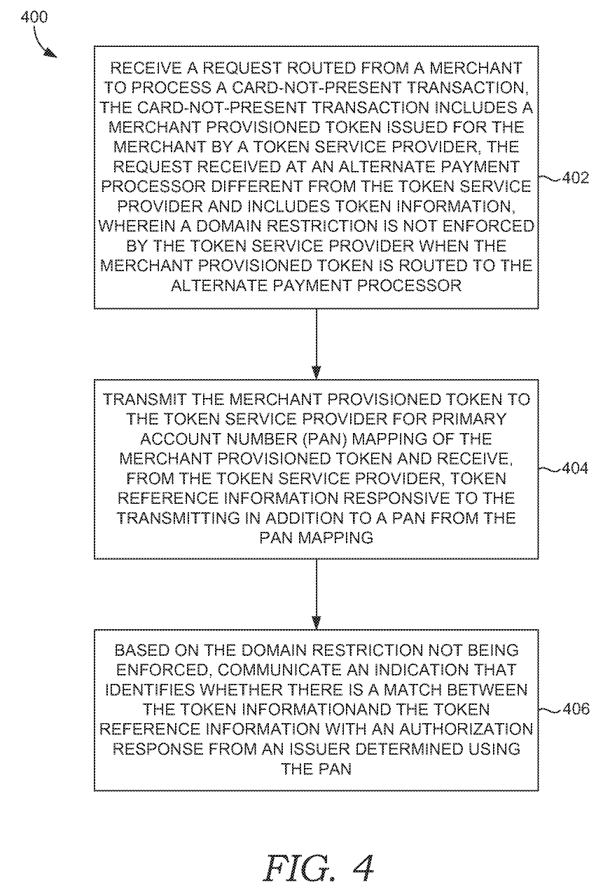

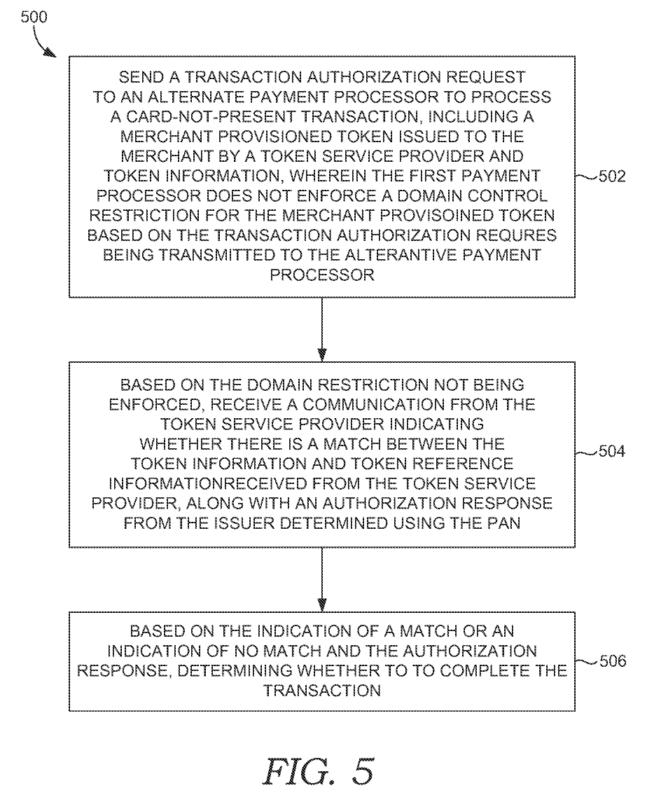

With reference now to FIGS. 4-5, block diagrams are provided respectively illustrating methods 400-500. Each block of the methods may comprise a computing process performed using any combination of hardware, firmware, or software. For instance, the methods can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. The methods may be implemented in whole or in part by components of operating environment 100.

Turning now to FIG. 4, a flow chart is illustrated for an example method 400 for verifying a transaction for a card-not-present transaction when domain restrictions are not enforced. In aspects, the method may be used by an alternate payment processor when a token service provider does not enforce the domain control restriction for which the merchant provisioned token was provisioned. That is, when the token service provider does not indicate that a merchant provisioned token was provisioned for use with a specific merchant or for a specific purpose.

Method 400 begins at block 402 with receiving a request routed from a merchant to process a card-not-present transaction. The card-not-present transaction includes a merchant provisioned token issued for the merchant by a token service provider. The request is received at an alternate payment processor different from the token service provider and includes token information. In aspect, the request may include other information, such as a token requestor ID or a type of transaction corresponding to the transaction request.

At block 404, the method 400 further comprises transmitting the merchant provisioned token to the token service provider for personal account number (PAN) mapping of the merchant provisioned token. For instance, the alternate payment processor may request a PAN from the token service provider to process the transaction. In aspects, the alternate payment processor requests an indication whether there are any restrictions for the merchant provisioned token, such as whether the merchant provisioned token was issued for a specific merchant or purpose. The method may further comprise receiving, from the token service provider, token reference information responsive to the transmitting in addition to a PAN from the PAN mapping. In aspects, the token service provider does not enforce the domain restriction by not returning an indication that the merchant provisioned token was issued for a specific domain or purpose. The method may further comprise, based on the domain restriction not being enforced, communicating an indication that identifies whether there is a match between the token information (e.g., a token requestor ID or a transaction type received from the merchant) and the token reference information (received from the token service provider) with an authorization response from an issuer determined using the PAN. As noted, in some cases, the token service provider does not indicate whether there are any restrictions for a specific merchant, thus providing an indication (or inference) that the merchant provisioned token was issued for a specific transaction type, such as a card-not-present transaction type.

At block 406, method 400 comprises communicating token reference information with an authorization request having the PAN. The authorization request may be communicated to the issuer. The method may further comprise declining the card-not-present transaction when there is no match between the token information received from the merchant (such as the token requestor ID or the transaction type) and the token reference information (received or otherwise inferred from the response to the PAN mapping provided by the token service provider). The method may further comprise the request being routed from the merchant terminal through a merchant acquirer, where the indication identifying whether there is a match is communicated to the merchant acquirer. The merchant acquirer may take action based on the received indication, such as approving or denying the transaction. The method may further comprise wherein the token service provider is the issuer. The method may further comprise wherein communicating the indication is based on the token service provider not verifying the domain restriction for the merchant provisioned token, e.g., not providing an indication that the merchant provisioned token was issue for use with a specific merchant or purpose. The method may further comprise the token information (received from the merchant) and the token reference information (received from the token service provider) each comprising a token requestor ID, and the indication identifies whether there is a match between a token requestor IDs. The method may further comprise the token information (received from the merchant) and the token reference information (received from the token service provider) each indicating a transaction type, and the indication identifies whether there is a match between the transaction types. The method may further comprise wherein the merchant provisioned token was provisioned specifically for an online domain of the merchant.

Turning now to FIG. 5, a flow chart is illustrated for an example method 500 for verifying a transaction for a card-not-present transaction when domain restrictions are not enforced. In aspects, the method may be used by a merchant routing a transaction authorization request to an alternate payment processor. At block 502, a merchant sends a transaction authorization request that includes token information for a merchant provisioned token retrieved by the merchant for conducting the transaction, to an alternate payment processor. In aspects, a token service provider does not to enforce the domain control restriction for which the merchant provisioned token was provisioned for based on the merchant routing the transaction authorization to the alternate payment processor and not the token service provider. That is, when the token service provider does not indicate that the merchant provisioned token was provisioned specifically for the merchant, the token service provider does not enforce the domain restrictions. A transaction authorization request may be send by a merchant to an alternate payment processor to process a card-not-present transaction. The transaction request can include a merchant provisioned token issued to the merchant by a token service provider and token information. The token information may include a type of transaction, such as whether the transaction is being conducted as a card-not-present transaction or a card present transaction, or other form of transaction. In aspects, the token information may include a token requestor ID, which may identify the merchant.

At block 604, an indication whether the token requestor ID or the transaction type is received from the alternate payment processor, and the indication may be received based on a token service provider not enforcing domain restrictions for the merchant provisioned token. The alternate payment processor sends the merchant provisioned token and the token information received from the merchant acquirer to the token service provider for PAN mapping. The token service provider maps the merchant provisioned token provided by the alternate payment processor to the PAN. The request from the alternate payment processor to the token service provider may include a request for to identify whether there is a domain control restriction for the merchant provisioned token. In this aspect, the domain index having the domain restrictions, i.e., identifying the merchant for which the merchant provisioned token was specifically issued, thus indicating that a transaction may not be completed when the merchant provisioned token is received from a source, is accessible by the token service provider but not the alternate payment processor. The token service provider does not indicate the domain control restriction in response to the request from the alternate payment processor, thereby not enforcing the domain control restriction.

The method further comprises, at block 606, responsive to the domain restriction not being enforced, receiving a communication from the alternate payment processor indicating whether there is a match between the token information received from the merchant and the token reference information received from the token service provider (e.g., whether there is a match between the token requestor ID or the transaction type, along with an authorization response from the issuer determined using the PAN). The method further comprising, based on the indication of a match or an indication of no match by the alternate payment processor, using the authorization response from issuer determined using the PAN to complete the transaction or deny the transaction.

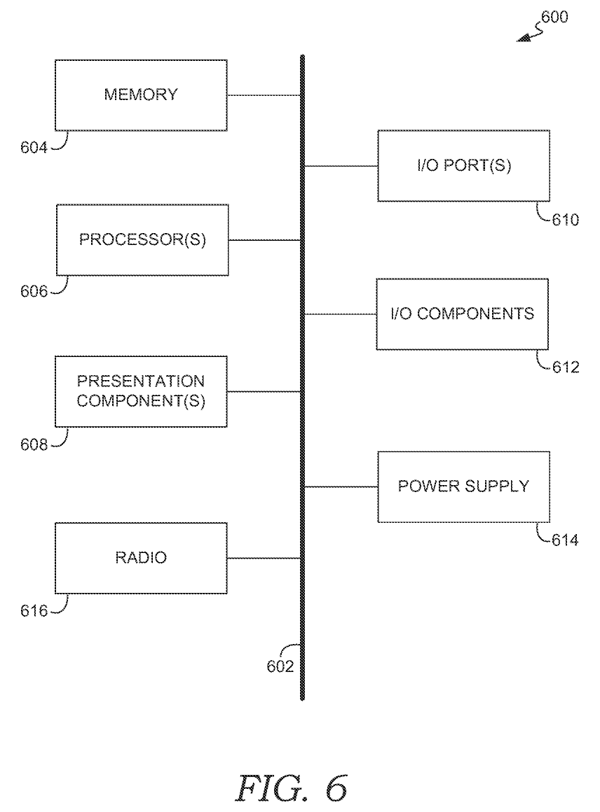

Having described an overview of some embodiments of the present technology, an example computing environment in which embodiments of the present technology may be implemented is described below in order to provide a general context for various aspects of the present technology. Referring now to FIG. 6 in particular, an example operating environment for implementing embodiments of the present technology is shown and designated generally as computing device 600. Computing device 600 is but one example of a suitable computing environment and is not intended to suggest any limitation as to the scope of use or functionality of the technology. Computing device 600 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 6, computing device 600 includes bus 602, which directly or indirectly couples the following devices: memory 604, one or more processors 606, one or more presentation components 608, input/output (I/O) ports 610, input/output components 612, and illustrative power supply 614. Bus 602 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. In addition, processors have memory. The inventors recognize that such is the nature of the art, and reiterate that the diagram of FIG. 6 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 600. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 604 includes computer storage media in the form of volatile or non-volatile memory. The memory may be removable, non-removable, or a combination thereof. Example hardware devices include solid-state memory, hard drives, optical-disc drives, etc. Computing device 600 includes one or more processors that read data from various entities, such as memory 604 or I/O components 612. Presentation component(s) 608 presents data indications to a user or other device. Example presentation components include a display device, speaker, printing component, vibrating component, etc.

I/O ports 610 allow computing device 600 to be logically coupled to other devices, including I/O components 612, some of which may be built-in. Illustrative components include a microphone, joystick, game pad, satellite dish, scanner, printer, wireless device, etc. The I/O components 612 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 600. Computing device 600 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 600 may be equipped with accelerometers or gyroscopes that enable detection of motion. The output of the accelerometers or gyroscopes may be provided to the display of computing device 600 to render immersive augmented reality or virtual reality. Power supply maybe any power supply suitable for use by computing device 600, and radio 616 may include a transmitter or receiver for facilitating wireless communication by computing device 600.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With continued reference to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether. In aspects, merchant acquirer server 106, issuer server 108, token service provider server 116, and alternate payment processor server 114 comprises one or more computing device that execute the described functionality, such as computing device 600.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters” using communication media described herein. Also, the word “initiating” has the same broad meaning as the word “executing or “instructing” where the corresponding action can be performed to completion or interrupted based on an occurrence of another action. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology described with reference to a distributed computing environment; however the distributed computing environment depicted herein is merely an example. Components can be configured for performing novel aspects of embodiments, where the term “configured for” can refer to “programmed to” perform particular tasks or implement particular abstract data types using code. Further, while embodiments of the present technology may generally refer to the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

1. A computer-implemented method performed by one or more processors, the method comprising:
receiving a request routed from a merchant to process a card-not-present transaction, the card-not-present transaction includes a merchant provisioned token issued for the merchant by a token service provider, the request received at an alternate payment processor different from the token service provider and includes
token information, the merchant provisioned token having corresponding domain
information within a domain index stored in a database inaccessible to the alternate
payment provider, wherein the merchant provisioned token is based on a domain restriction not enforced by the token service provider when the merchant provisioned token is routed to the alternate payment processor;
transmitting the merchant provisioned token to the token service provider for primary account number (PAN) mapping of the merchant provisioned token;
receiving, from the token service provider, token reference information responsive to the transmitting in addition to a PAN from the PAN mapping; and
based on the domain restriction not being enforced and the database having
the domain index being inaccessible to the alternative payment provider, communicating an indication that identifies whether there is a match between the
token information received from the merchant and the token reference information received from the token service provider with an authorization response from an issuer determined using the PAN.

2. The computer-implemented method of claim 1, further comprising communicating the token reference information with an authorization request having the PAN, the authorization request communicated to the issuer.

3. The computer-implemented method of claim 1, further comprising declining the card-not-present transaction when there is no match between the token information from the merchant and the token reference information from the token service provider.

4. The computer-implemented method of claim 1, wherein the request routed from the merchant is routed through a merchant acquirer and the indication identifying whether there is a match is communicated to the merchant acquirer.

5. The computer-implemented method of claim 1, wherein the token service provider is the issuer.

6. The computer-implemented method of claim 1, wherein communicating the indication is based on the token service provider not verifying the domain restriction for the merchant provisioned token in response to the PAN mapping.

7. The computer-implemented method of claim 1, wherein the token information from the merchant and the token reference information from the token service provider each comprise a token requestor identification (ID) identifying the merchant, and the indication identifies whether there is a match between a token requestor ID of the token information and a token requestor ID of the token reference information.

8. The computer-implemented method of claim 1, wherein the token information from the merchant and the token reference information from the token service provider each comprise a type of transaction, and the indication identifies whether there is a match between a type of transaction of the token information and a type of transaction of the token reference information.

9. The computer-implemented method of claim 1, wherein the merchant provisioned token was provisioned specifically for an online domain of the merchant.

10. A system comprising: at least one processor; and
one or more computer storage media storing computer readable instructions thereon that when executed by the at least one processor cause the at least one processor to perform operations comprising:
receiving a request routed from a merchant to process a card-not
present transaction, the card-not-present transaction includes a merchant
provisioned token issued for the merchant by a token service provider, the request received at an alternate payment processor different from the token service provider and includes token information comprising a token requestor identification (ID) identifying the merchant, the merchant
provisioned token having corresponding domain information within a
domain index stored in a database inaccessible to the alternate payment
provider;
transmitting the merchant provisioned token to the token service provider for primary account number (PAN) mapping of the merchant provisioned token;
receiving, from the token service provider, token reference information responsive to the transmitting in addition to a PAN from the PAN mapping, the token reference information also comprising the token requestor ID and received without indicating the merchant provisioned token was provisioned specific to the merchant; and
based on no indication of the merchant provisioned token being
provisioned specific to the merchant and the database having the domain
index being inaccessible to the alternative payment provider, communicating an indication that identifies whether there is a match between the token requestor ID received with the token information from the merchant and the token requestor ID received from the token service provider within the token reference information with an authorization response from an issuer determined using the PAN.

11. The system of claim 10, further comprising communicating the token reference information from the token service provider with an authorization request having the PAN, the authorization request communicated to the issuer.

12. The system of claim 10, further comprising declining the card- not-present transaction when there is no match between the token requestor ID of the token reference information from the merchant and the token requestor ID received from the token service provider within the token reference information.

13. The system of claim 10, wherein communicating the indication is based on the token service provider not verifying a domain restriction for the merchant provisioned token.

14. The system of claim 10, wherein the token service provider is the issuer.

15. One or more computer storage media storing computer readable instructions thereon that when executed by a processor cause the processor to perform operations comprising:
receiving a request routed from a merchant to process a card-not-present
transaction, the card-not-present transaction includes a merchant provisioned token issued specifically for the merchant by a token service provider, the request
received at an alternate payment processor different from the token service provider
and includes a token information comprising a type of transaction, the merchant
provisioned token having corresponding domain information within a domain
index stored in a database inaccessible to the alternate payment provider; transmitting the merchant provisioned token to the token service provider
for primary account number (PAN) mapping of the merchant provisioned token; receiving, from the token service provider, a token information responsive
to the transmitting in addition to a PAN from the PAN mapping, the token reference information received without indicating the merchant provisioned token was provisioned specific to the merchant and also indicating the type of transaction for the merchant provisioned token; and
based on no indication of the merchant provisioned token being provisioned specific to the merchant and the database having the domain index being
inaccessible to the alternative payment provider, communicating an indication that identifies whether there is a match between the type of transaction as received with the token reference information from the merchant and a type of transaction indicated by the token reference information from the token service provider with an authorization response from an issuer determined using the PAN.

16. The media of claim 15, further comprising communicating the token reference information with an authorization request having the PAN, the authorization request communicated to the issuer.

17. The media of claim 15, further comprising declining the card- not-present transaction when there is no match between the transaction type received by the merchant and the transaction type as indicated by the token reference information received from the token service provider.

18. The media of claim 15, wherein communicating the indication is based on the token service provider not verifying a domain restriction for the merchant provisioned token.

19. The media of claim 15, wherein the token service provider is the issuer.

20. The media of claim 15, wherein the merchant provisioned token was provisioned specifically for an online domain of the merchant.
